(19) United States
(12) Patent Application Publication
(10) Pub. No.: US 2006/0092157 A1
(43) Pub. Date: May 4, 2006

(54) Method of defining a surface or a volume

(75) Inventor: Cristian Lorenz, Hamburg (DE)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/536,917

(22) PCT Filed: Nov. 25, 2003
(86) PCT No.: PCT/IB03/05391

§ 371 Date: May 31, 2005

(30) Foreign Application Priority Data
Dec. 3, 2002 (DE) 102562849

(51) Int. Cl. G06T 17/00

(52) U.S. Cl. 345/424

(57) ABSTRACT

The invention relates to a method of defining a surface or a volume in a three-dimensional, and in particular medical, data set. At least two starting lines (11, 13), which preferably lie in mutually perpendicular planes and intersect one another, having been preset, contour lines (31) that lie between the starting lines (11, 13) are determined by Fourier transformation. These contour lines (31) form a surface structure (63) from which a surface can be determined by polygonization, e.g. by triangulation. If the starting lines are closed, the surface too is closed and defines a volume.

The invention relates to a method of defining a surface or a volume in a three-dimensional data set that contains, in particular, medical data. The invention also relates to an examination system for carrying out this method and to a computer program for controlling the examination system.

A volume in a three-dimensional medical data set may, for example, define what is termed a “volume of interest” (VOI) to which further image-processing steps are to be confined. The confinement to the VOI reduces the amount and cost of computing work, because there are no image-processing steps outside the VOI, and improves the quality of the image because disruptive or interfering structures that are situated outside the VOI are ignored.

In known methods of the kind mentioned in the opening paragraph, cylinder-like volumes are defined and represented in a three-dimensional data set. These volumes are generated by base surfaces of any desired shape that propagate through the data set in a selectable direction. The base surfaces may be defined manually, e.g. by a doctor. It is a disadvantage of this method that it is restricted solely to cylinder-like volumes. As a rule however, it is necessary for volumes or surfaces of random shapes to be represented when what is to be considered is a human organ.

There is described in U.S. 2001/0033283 A1 a method that calculates a volume of random shape from two-dimensional, manually presettable starting lines by means of a method of variation. This method, however, calls for a great deal of computing work and is very time-intensive.

It is therefore an object of the present invention to specify a method that makes it possible for surfaces and volumes of random shapes to be defined with less computing work than is needed with known methods.

This object is achieved in accordance with the invention by a method of defining a surface or a volume in a three-dimensional data set that contains in particular medical data, having the following steps:

a) presetting of at least two starting lines situated in a three-dimensional space, the space being preset by the three-dimensional data set,

b) generation of a surface structure from the starting lines by means of a Fourier transformation,

c) generation of a surface, and in particular a surface of a volume, from the surface structure.

In contrast to known methods, it is surfaces, and hence, when the surfaces are closed, volumes too, that are defined. This considerably reduces the computing work compared with the known application of the variation method.

Claim 2 describes a preferred embodiment of the generation of the surface structure that requires only a small amount of computing work.

In claim 3 is described a preferred way of generating a surface from the surface structure.

In claim 4, the starting lines can be preset in a three-dimensional data set that has been reconstructed from acquired measurements.

The embodiment described in claim 5 is a method in which the starting lines are divided into part-lines. This gives improved quality for the surfaces and volumes defined.

In claims 6 and 7 the starting lines are closed, thus causing the surface defined to enclose a volume.

An examination system for carrying out the method according to the invention is described in claim 8. Claim 9 defines a computer program for controlling the examination system.

These and other aspects of the invention are apparent from and will be elucidated with reference to the embodiments described hereinafter.

In the drawings:

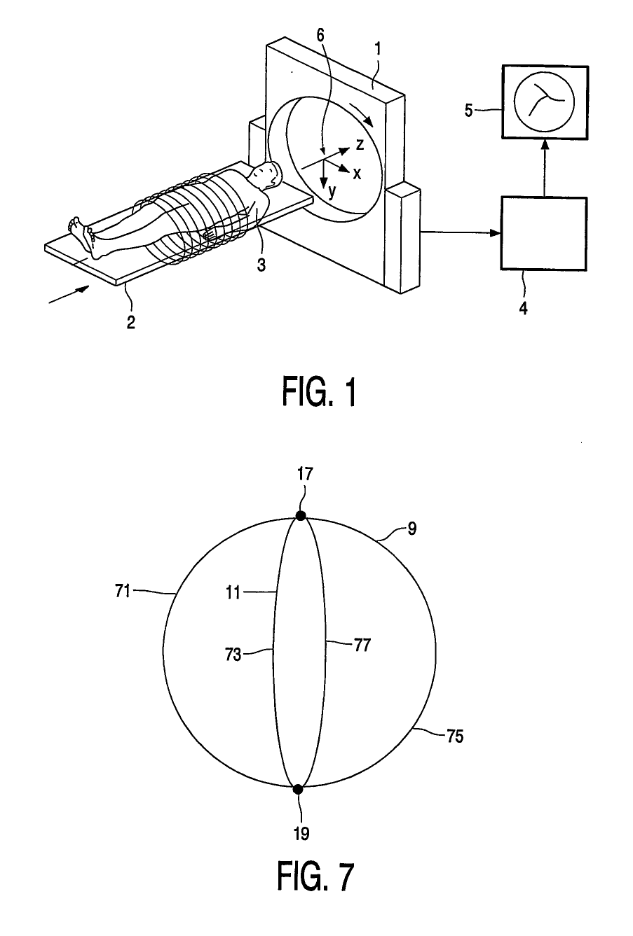

FIG. 1 is a diagrammatic view of an examination system with which the method according to the invention can be carried out.

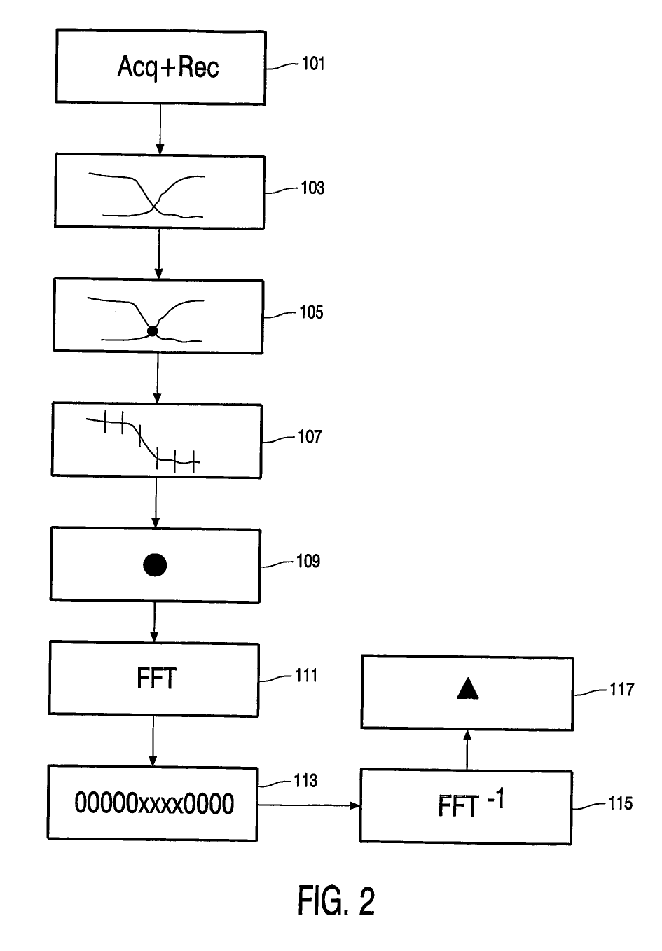

FIG. 2 is a flow chart for the method according to the invention.

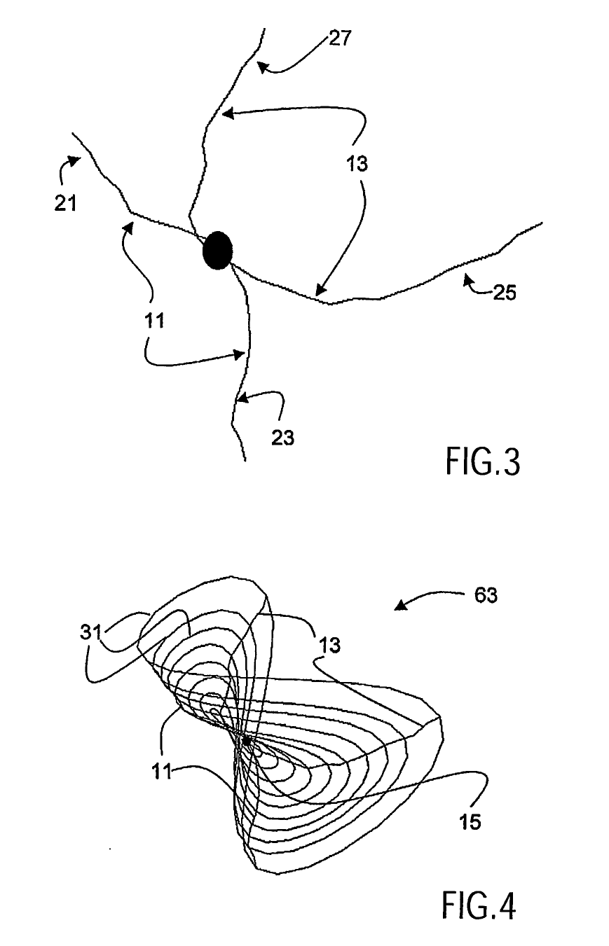

FIG. 3 shows two intersecting starting lines,

FIG. 4 shows a surface structure.

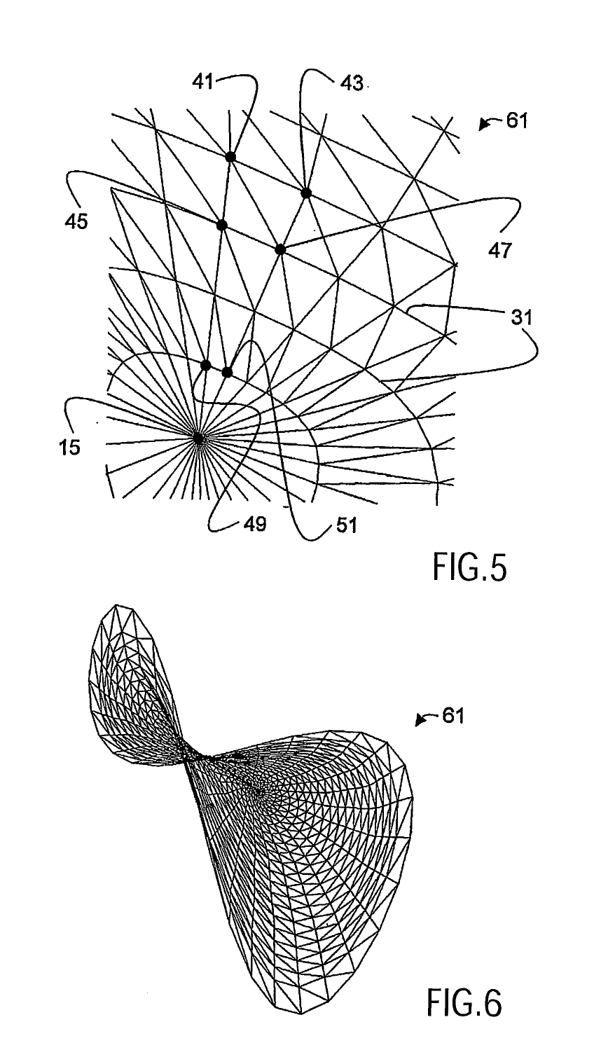

FIG. 5 is a view of part of a surface after triangulation of the surface structure.

FIG. 6 is an overall view of the surface, and

FIG. 7 shows two intersecting, closed starting lines.

FIG. 1 shows a known computer tomograph 1 with which a three-dimensional data set can be produced. A patient 3 is situated on a displaceable table top 2. A three-dimensional region of the patient, the region for examination, can be examined in this case either as a sequence of adjoining parallel slice images or by spiral acquisition in which the X-ray source moves in a spiral relative to the region for examination. In the course of this, measurements are acquired by a detector unit and a three-dimensional data set, which represents the three-dimensional distribution of absorption in the region for examination, is reconstructed from these measurements. Each item of data in the data set is unambiguously located by three coordinates. This data set is stored and processed in an image-processing computer 5. The image that is generated when this is done is shown on a monitor 5.

The method according to the invention can also be carried out with some other examination system that enables a data set to be generated whose voxel image values correspond to a given parameter or a given property, such as elastic or magnetic properties. This system may, for example, be a magnetic resonance or ultrasound unit.

FIG. 2 shows the sequence followed in a method of measurement, reconstruction and image-processing that can be carried out with the computer tomograph shown in FIG. 1. What is shown here in the case of the present embodiment is the definition of a surface that takes place in the image-processing computer 4. In other embodiments, the image-processing according to the invention may also take place on a plurality of computers or on one different computer.

Following the acquisition of measurements and the reconstruction of a three-dimensional data set in step 101, two starting lines 11, 13, which lie in mutually perpendicular planes and intersect, are selected in the volume-defining data set in step 103. These lines are shown in FIG. 3. The selection of the starting lines 11, 13 may be carried out at the image-processing computer 4 by a doctor, for example. For this, two mutually perpendicular layers from the data set are shown on the monitor 5 and by means of suitable software the doctor draws respective ones of the starting lines 11, 13 in each of the layer images.

The definition of the starting lines 11, 13 may also be performed automatically by presetting a starting point in the three-dimensional data set manually and having the image-processing computer 4 calculate the starting lines 11, 13, starting from this starting point, by following a preset algorithm. In this way, starting from the starting point, the next point or voxel image value may, for example, be that which shows the least difference from the voxel image value for the starting point.

In other embodiments, more than two mutually intersecting starting lines 11, 13 may also be defined. The method according to the invention may also be carried out if the starting lines do not lie in mutually perpendicular planes and do not intersect.

In step 105, the image-processing computer 4 determines the point 15 at which the two starting lines 11, 13 intersect, which is shown in FIG. 3. The starting lines 11, 13 are each divided by the point of intersection 15 into two part-lines 21, 23 and 25, 27 respectively, so that all the part-lines 21, 23, 25, 27 originate from the point of intersection 15.

In step 107, the part-lines are divided into sections so that each part-line 21, 23, 25, 27 has the same number N of sections. Each part-line may, for example, be divided into N=128 sections. Each section is also assigned a section point in three dimensions. The section point of a section may, for example, be its center point. The length of the sections in each part-line is constant. In other embodiments, this length may be selected as desired for each section and each part-line.

In step 109, the section points are combined into N point groups, with each point group having one section point from each part-line 21, 23, 25, 27. In the present embodiment each of the N point groups thus comprises four section points. The point groups are formed as follows: starting from the point of intersection, the first section points on each part-line 21, 23, 25, 27 are combined to form a first point group. In a second point group there are the section points that, viewed from the point of intersection, are in the second position on each part-line 21, 23, 25, 27. This process continues for all the remaining N-2 point groups and 4(N-2) section points.

If, in other embodiments, the starting lines do not have a point of intersection then step 105 is dispensed with. In step 107, it is then the starting lines rather than the part-lines that are divided into sections as described above. The sections have three-dimensional section points assigned to them and these are combined into point groups in step 109 in the way described above.

In what follows, a surface structure 63, which is shown in FIG. 4, is determined by means of a known Fourier transformation. To do this, in step 111 the section points in each point group, i.e. four section points at a time in the present embodiment, are Fourier transformed in each direction in space, i.e. the x-coordinates for example of the section points in a point group are first Fourier transformed. After this, the y coordinates of the section points in the point group are Fourier transformed and then the z coordinates. This Fourier transformation is carried out for the section points in all the point groups. The coordinate designations are those shown for the coordinate system 6 in FIG. 1.

To enable contour anchor points for the surface structure 63 also to be obtained in the regions between the part-lines 21, 23, 25, 27, the result of the Fourier transformation is zero-padded in step 113 for each point group. The number of zeroes is determined by the desired number of contour anchor points. If, for example, 128 anchor points were desired, the result of the Fourier transformation would be padded with 124 zeroes. When this is done, the result of the Fourier transformation is as it were framed by zeroes, i.e. half the zeroes to be inserted are placed before the first value of the Fourier transform and half are placed after its last value. In the same way, zeroes are inserted before and after the results of the Fourier transformations of the y and z coordinates.

In the back-transformation in step 155, the point groups padded with zeroes are reverse Fourier transformed in each direction in space. What this means is that, as in the forward transformation, the x coordinates, for example, of the Fourier transformed section points in a point group, including the inserted zeroes, are reverse Fourier transformed first. After this, the y coordinates and then the z coordinates of the corresponding values in a point group are reverse Fourier transformed. This reverse Fourier transformation is carried out for the Fourier transformed section points and the inserted zeroes of all the point groups.

The Fourier transformation and the reverse Fourier transformation may be performed by, for example, a known fast Fourier transformation (FFT) and a reverse FFT.

If each point group in each direction of space was padded with 124 zeroes, each point group comprises not four three-dimensional section points but 128 points after the back-transformation. The points into each point group are arranged on closed contour lines 31, as shown in FIG. 4. Hence, each of these contour lines 31 represents a point group after the back-transformation. The contour lines 31 are arranged concentrically to the point of intersection 15 and form the surface structure 63.

In step 117, a surface is generated from the surface structure 63 by polygonization. There are a number of methods of polygonization that are known and that can also be used here and of these a form of triangulation will be explained below.

Because each contour line 31 has the same number of points, the space between two successive contour lines 31 can be defined by trapezia, with the corners of each trapezium being formed by two pairs of points (e.g. 41, 43 and 45, 47 in FIG. 5), which pairs lie on respective ones of the two successive contour lines 31 and are adjacent to one another. Each trapezium is divided into two triangles by a diagonal. The region between the point of intersection 15 and the innermost contour line 31 on the other hand is set out directly in triangles, with the corners of each triangle being the point of intersection 15 and two mutually adjacent points, e.g. 49, 51 on the innermost contour line 31. The surface 61 obtained from the contour lines 31 by triangulation is shown in FIG. 6.

The method according to the invention can also be applied to closed starting lines 9, 11 that intersect at two points of intersection 17, 19. Closed starting lines 9, 11 are shown by way of example in FIG. 7, with starting line 9 lying in the plane of the drawing and starting line 11 being oriented perpendicularly to this plane. Two points of intersection 17, 19 would have to be determined in this case and the resulting four part-lines 71, 73, 75, 77 would each have to originate from one point of intersection 17 and terminate at the second point of intersection 19. The process of dividing the four part-lines 71, 73, 75, 77 into sections and the other steps of the method could be taken over substantially unchanged. The triangulation would produce a closed surface and would thus define a volume.

To generate a volume from a closed surface, the space enclosed by the surface can be divided into three-dimensional elements of volume (so-called voxels) to which values, e.g. the absorption values found by the computer tomograph, can then be assigned.

### LIST OF REFERENCE NUMERALS

1 Computer tomograph
2 Table top
3 Patient
4 Image-processing computer
5 Monitor
6 Coordinate system
7, 9, 11, 13 Starting lines
15, 17, 19 Points of intersection
21 . . . 27 Part-lines
31 Contour lines
41 . . . 51 Points on the contour lines
61 Surface
63 Surface structure
71. . . 77 Part-lines

1. A method of defining a surface or a volume in a three-dimensional data set that contains in particular medical data, having the steps of:
a) presetting of at least two starting lines (11, 13) lying in a three-dimensional space, the space being preset by the three-dimensional data set,
b) generation of a surface structure (63) from the starting lines (11, 13) by means of a Fourier transformation,
c) generation of a surface (61), and particularly a surface of a volume, from the surface structure (63).

2. A method as claimed in claim 1, wherein step b) comprises the following steps:
division of each starting line (11, 13) into sections, each starting line (11, 13) having the same number of sections and the location of each section in the three-dimensional space being defined by a section point,
formation of point groups, each point group comprising a section point on each starting line,
Fourier transformation of the section points in each point group,
addition of zeroes to the Fourier transformed section points in each point group (zero padding),
generation of a surface structure by reverse Fourier transformation of the Fourier transformed section points and the added zeroes in each point group.

3. A method as claimed in claim 1, wherein a polygonization, and in particular a triangulation, of the surface structure is carried out in step c).

4. A method as claimed in claim 1, wherein step a) comprises the following steps:
acquisition of measurements with an examination system, and in particular with a computer tomograph (1), a magnetic resonance unit or an ultrasound unit,
reconstruction of a three-dimensional data set from the measurements,
presetting of at least two starting lines (11, 13) lying in the three-dimensional space, the three-dimensional space being preset by the three-dimensional data set.

5. A method as claimed in claim 1, wherein the at least two starting lines (11, 13) have at least one point of intersection (15) in step a), and step b) comprises the following steps:
determination of the at least one point of intersection (15),
division of each starting line (11, 13) into part-lines (21 . . . 27) at each point of intersection,
division of each part-line into sections, each part-line having the same number of sections and the location of each section in the three-dimensional space being defined by a section point,
formation of point groups, each point group comprising a section point on each part-line.
Fourier transformation of the section points in each point group,
addition of zeroes to the Fourier transformed section points in each point group (zero padding),
generation of a surface structure by reverse Fourier transformation of the Fourier transformed section points and the added zeroes in each point group.

6. A method as claimed in claim 5, wherein the starting lines are closed.

7. A method as claimed in claim 1, wherein the starting lines are closed.

8. An examination system, in particular a medical examination system, for carrying out the method as claimed in claim 1, having
an acquisition unit for acquiring measurements,
a reconstruction unit for reconstructing a three-dimensional data set from the measurements,
an image-processing unit (4) for defining a surface (61) or a volume,
a control unit for controlling the acquisition unit, reconstruction unit and image-processing unit (4) in the following steps:
acquisition of measurements,
reconstruction of a three-dimensional data set from the measurements,
presetting of at least two starting lines (11, 13) lying in a three-dimensional data set, and in particular a medical data set,
generation of a surface structure (63) from the starting lines (11, 13) by means of a Fourier transformation,
generation of a surface (61), and particularly a surface of a volume, from the surface structure (63).

9. A computer program for a control unit for controlling an acquisition unit, reconstruction unit and image-processing unit (4) of an examination system for carrying out the method as claimed in claim 1, in the following sequence:
acquisition of measurements,
reconstruction of a three-dimensional data set from the measurements,
presetting of at least two starting lines (11, 13) lying in a three-dimensional, and in particular a medical, data set,
generation of a surface structure (63) from the starting lines (11, 13) by means of a Fourier transformation,
generation of a surface (61), and particularly a surface of a volume, from the surface structure (63).
